(19) United States
(12) Patent Application Publication
(10) Pub. No.: US 2005/0148331 A1
(43) Pub. Date: Jul. 7, 2005

(54) Presence status update system and method in a mobile communication network

(75) Inventors: Amir Sharon, Ramat-Hasharon (IL); Charles Monte, San Rafael, CA (US); Vladimir Holostov, Kfar Saba (IL); Amit Shackak, Petah-Tiqwa (IL)

Correspondence Address: FARSHAD JASON FARHADIAN;CENTURY IP LAW GROUP, P.O. BOX 7333, NEWPORT BEACH, CA, 92658-7333, US

(73) Assignee: IXI Mobile (R&D) Ltd.

(21) Appl. No.: 10/755,058

(22) Filed: Jan. 7, 2004

(51) Int. Cl. H04Q 7/00

(52) U.S. Cl. 455/435.1

(57) ABSTRACT

A system for providing presence status for a mobile device is provided. The system comprises a monitoring unit for monitoring changes in the presence status of the mobile device; and a transmitter for transmitting presence status data to a server system, in response to detecting a change in the presence status of the mobile device, wherein the presence status indicates whether the mobile device can engage in a data communication session, and wherein the server system notifies a second mobile device of the presence status of the mobile device, in real time.

### BACKGROUND

1. Field of Invention

The present invention relates generally to mobile communication services and, more particularly, to a system and method for automatically updating the presence status data for a mobile communications device.

### COPYRIGHT & TRADEMARK NOTICES

A portion of the disclosure of this patent document contains material, which is subject to copyright protection. The owner has no objection to the facsimile reproduction by any one of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is for providing an enabling disclosure by way of example and shall not be construed to limit the scope of this invention to material associated with such marks.

2. Related Art

Mobile communication technology and communication related services continue to grown at a rapid pace. The advent of mobile communication networks and mobile communication devices, such as cellular telephones, was due to the need for real-time access to information and people. Today, this need is replaced by an “expectation” to access information or parties in real-time, to the extent that some users experience frustration, when they cannot immediately reach a third party, for example, if they receive a busy signal or no response.

Text messaging has helped alleviate some of this frustration. That is, many mobile devices, in addition to voice communications, also now support data communications for communicating text messages in the form of short messages or instant messages. Unfortunately, however, certain problems are also associated with supporting data communications in a mobile communication environment. Particularly, when a mobile device is used for voice communications, data communication services are interrupted.

This interruption in data service is implemented to simplify handling voice and data communicated to a mobile device at the same time. Regretfully, the implemented solution completely interrupts data service when a voice communication is initiated. This is to the complete detriment of the data service user, whose communication is interrupted by a voice service user without any scrutiny. Even worse, the data service user is not notified of the reason for the interruption in data communication.

For example, a first user may be wirelessly communicating with a second user via an instant messaging data service. If the second user receives a voice call from a third party, then no more data communicated by the first user will be displayed on the second user's mobile device, until after the voice call is terminated. Meanwhile, the first user cannot determine whether this delay or interruption in data communication is due to a bad connection or other reason.

For the above reasons, a method and system is needed that can provide presence status information for a mobile device, wherein the status information indicates whether the mobile device is available for data communication.

### SUMMARY

One or more embodiments of the present invention are directed to a method of updating presence status of a mobile device. The method comprises monitoring changes in the presence status of the mobile device; and transmitting presence status data to a server system, in response to detecting a first change in the presence status of the mobile device, wherein the presence status indicates whether the mobile device can engage in a data communication session.

For purposes of summarizing, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein.

In one embodiment, the presence status data is transmitted to the server system in real time, wherein the server system is configured to notify a third party of the presence status of the mobile device. A voice telephony system determines the presence status of the mobile device based on voice session information. And, a third party is notified of the presence status, in response to transmitting a message addressed to the mobile device.

The presence status of the mobile device can be automatically changed based on whether the mobile device is in use for voice communication. Further, the presence status of the mobile device can be automatically changed based on whether the mobile device is in an open position, turned on, or in a vibration or meeting mode.

In accordance with another embodiment, a method of updating presence status of a mobile device comprises automatically monitoring changes in the presence status of the mobile device; and detecting a change in the presence status of the mobile device, in real time; wherein the presence status indicates whether the mobile device can engage in a data communication session.

In response to receiving the presence status data from the mobile device, an alert is generated to communicate the presence status of the mobile device to another mobile device. In some embodiments, the alert is generated in response to receiving a message addressed for communication to the mobile device. A change in the presence status of the mobile device can be detected, based on whether the mobile device is in use for voice communications or in an open position or turned on, for example.

In accordance with another embodiment, a system for providing presence status of a first mobile device is provided. The system comprises a monitoring unit for monitoring changes in the presence status of the first mobile device; and a transmitter for transmitting presence status data to a server system, in response to detecting a change in the presence status of the first mobile device, wherein the presence status indicates whether the mobile device can engage in a data communication session, and wherein the server system notifies a second mobile device of the presence status of the mobile device, in real time.

In one embodiment, the second mobile device is notified of the presence status of the first mobile device, in response to the second mobile device communicating at least one data message addressed to the first mobile device, when the presence status indicates that the first mobile device is in use for voice communications.

These and other embodiments of the present invention will also become readily apparent to those skilled in the art from the following detailed description of the embodiments having reference to the attached figures, the invention not being limited to any particular embodiments disclosed.

### BRIEF DESCRIPTION OF THE DRAWINGS

Embodiments of the present invention are understood by referring to the figures in the attached drawings, as provided below.

FIG. 1 illustrates an exemplary communications environment in accordance with one or more embodiments of the invention;

FIG. 2 is a flow diagram of a real time method for updating presence status for a mobile device in a communications network, in accordance with one or more embodiments; and

FIGS. 3A and 3B are block diagrams of hardware and software environments in which a system of the present invention may operate, in accordance with one or more embodiments.

Features, elements, and aspects of the invention that are referenced by the same numerals in different figures represent the same, equivalent, or similar features, elements, or aspects, in accordance with one or more embodiments.

### DETAILED DESCRIPTION

An electronic system and corresponding methods, according to an embodiment of the present invention, facilitate and provide an automatic real time update system for notifying a third party of presence information of a mobile device in a communications network.

The terms electronic services, services, and online services are used interchangeably herein. The services provided by the system of this invention, in one or more embodiments, are provided by a service provider. A service provider is an entity that operates and maintains the computing systems and environment, such as server systems and infrastructure that enable the delivery of information and services. Typically, server architecture comprises of components (e.g., hardware, software, and communication lines) that store and offer electronic or online data and voice communication services.

In the following, numerous specific details are set forth to provide a thorough description of various embodiments of the invention. Certain embodiments of the invention may be practiced without these specific details or with some variations in detail. In some instances, features not pertinent to the novelty of the system are described in less detail so as not to obscure other aspects of the invention.

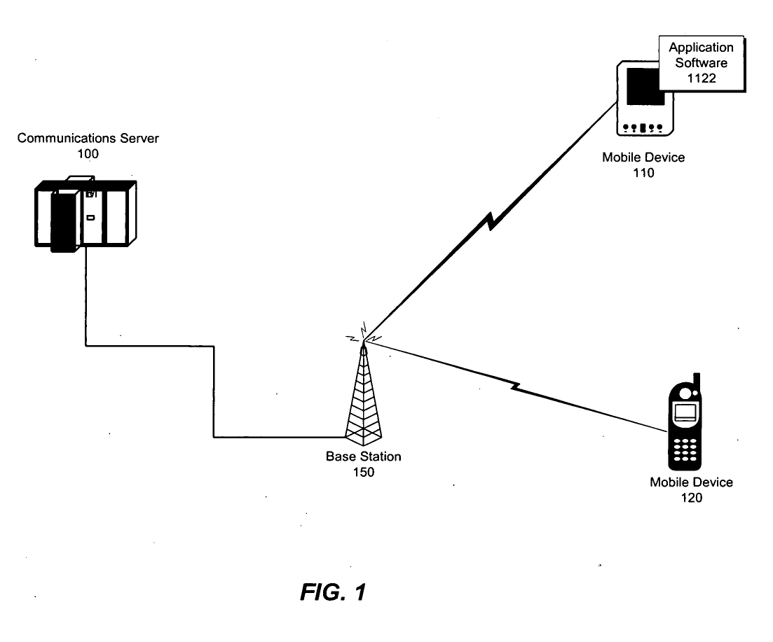

Referring to the drawings, FIG. 1 illustrates an exemplary communications environment in which the system of the present invention may operate. In accordance with one aspect of the system, the environment comprises plurality of mobile devices 110, 120 that communicate with a communications server 100, via a base station 150, for example.

Communications server 100, in accordance with one embodiment, provides data messaging service (e.g., instant messaging, short messaging, etc.), and may comprise or be coupled to one or more databases (not shown), for example, to update and store, presence status and configuration information for mobile devices 110, 120. The terms “connected,” “coupled,” or any variant thereof, mean any connection or coupling, either direct or indirect, between two or more elements. The coupling or connection between the elements can be physical, logical, or a combination thereof.

In one embodiment, communications server 100 communicates with mobile devices 110, 120 connected in the communications network illustrated in FIG. 1. The communications network provides the medium and infrastructure (i.e., base station 150) for transmitting digital or analog voice and data signals between communications server 100 and mobile devices 110, 120. In certain embodiments, mobile devices 110, 120 are cellular telephones communicating in a cellular telephone network, for example. Mobile devices 110, 120, communications server 100 and the communications network, in general, may be implemented over any type of mobile, fixed, wired or wireless communications system.

One of ordinary skill in the art will appreciate that the communications network of the invention may advantageously be comprised of one or a combination of various types of networks without departing from the scope of the invention. For example, in some embodiments, the communications network can comprise local area networks (LANs), wide area networks (WANs), public, private or secure networks, value-added networks, interactive television networks, wireless communications networks, two-way cable networks, satellite networks, interactive kiosk networks, cellular networks, personal mobile gateways (PMGs) and/or any other suitable communications network or part of the world wide web (i.e., the Internet).

In either context, mobile devices 110, 120 can communicate with a service provider to send and receive electronic packets of information, in form of electronic requests and responses. In one embodiment, the service provider is a wireless communications service provider (e.g., Sprint, AT&T or Verizon) to which a user may subscribe.

Some of the services provided by the system of the present invention may be implemented as application software installed and executed on mobile devices 110, 120, as provided in further detail below. In certain embodiments, the application software executed on mobile devices 110, 120 can act as client software that is in communication with communications server 100 or a service provider, for example.

Alternatively, in some embodiments, mobile devices 110, 120 may comprise a PMG device or communicate with a PMG device. The PMG architecture comprises a PMG server that can wirelessly communicate with a number of PMG enabled devices within the personal area of the user, thus providing a personal area network (PAN).

In addition, the PMG server can wirelessly communicate with remote server systems, such as a service provider or communications server 100, via a wireless system or communications network in a WAN. Thus, the PMG acts as an interface to seamlessly connect a PAN to a WAN, and as such the devices attached to the PAN or WAN can communicate with each other. A more detailed description of the PMG architecture is provided in U.S. patent application Ser. No. 09/850399, filed on May 7, 2001, the entire content of which is hereby incorporated by reference here.

As used herein, the terms service provider, communications server and communications network are to be viewed as designations of one or more computing environments that comprise application, client or server software for servicing requests submitted by respective software included in mobile devices or other computing systems connected thereto. These terms are not to be otherwise limiting in any manner. The application software 1122, for example, may be comprised of one or more modules that execute on one or more computing systems, as provided in further detail below.

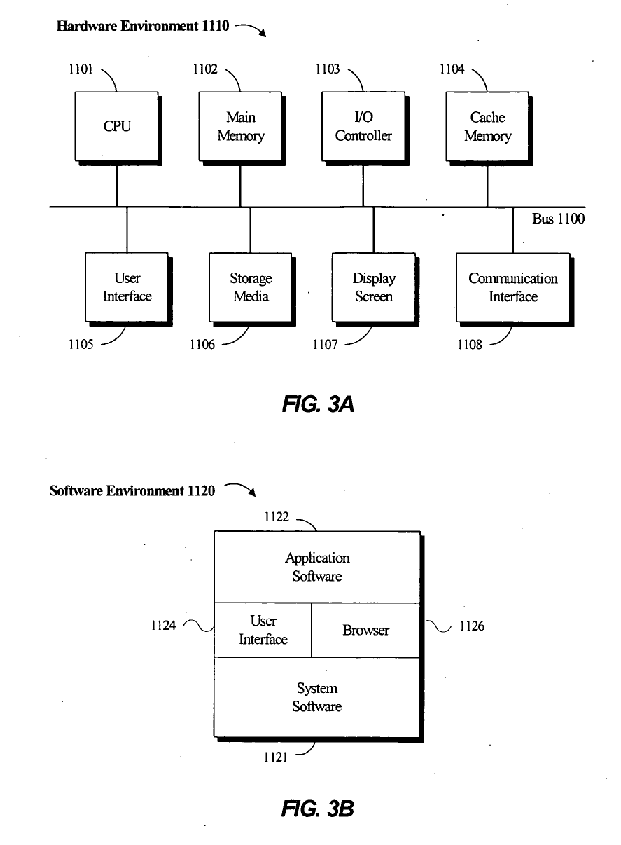

Referring to FIGS. 1 and 3A, in accordance with one aspect of the invention, application software 1122 may be implemented on a device or system other than mobile device 110. For example, application software 1122 or its components may be implemented, installed, and executed either in a singular or in a distributed environment. Certain components of the application software 1122 may be installed and executed on mobile devices 110, 120 while other components may be executed and installed on, for example, a PMG device, communications server 100, internet portals, service provider server systems, a telephony switching system or other computer systems and networks attached thereto to determine, update and/or report mobile device 110's presence status.

The presence status as used herein refers to a mode of operation for mobile device 110 during which data communicated from a third party (i.e., mobile device 120) cannot be viewed or accessed by the user of mobile device 110 in real-time. This inability for real-time delivery or access to the communicated data can arise under a plurality of circumstances.

In one embodiment, mobile device 110 may be engaged in voice communications with another mobile device. If mobile device 110 and the related communication infrastructure are not configured to handle voice and data communications simultaneously, then data communications is interrupted when voice communications is established. In another embodiment, closing or turning off mobile device 110 can prevent delivery or access to data communicated to mobile device 110. Yet, in other embodiments, a user may set mobile device 110 in a mode (e.g., vibration mode, meeting mode, etc.) which would also prevent the user from viewing the communicated data.

It should be noted, however, that the exemplary embodiments disclosed above are not to be construed to limit the scope of the invention to application software that is exclusively executed on mobile device 110, or a system that exclusively operates to provide real time support for updating presence status information. Other status information or data may be also updated according to the technological advantages that are the subject matter of this invention.

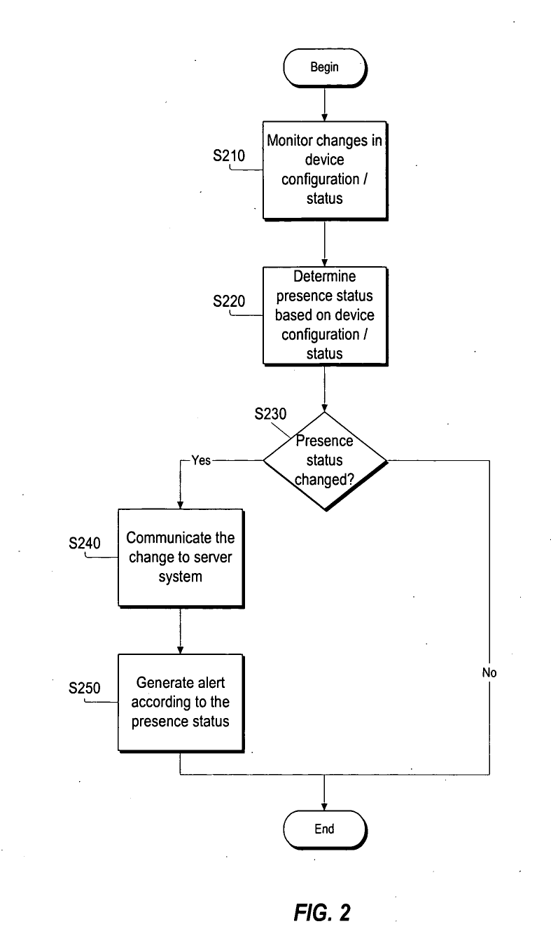

Referring to FIGS. 1 and 2, in accordance with one aspect of the invention, communications server 100 monitors changes in device configuration or communication status (S210). This monitoring can be performed either through direct communication with mobile device 110 or communication with other telephony systems (e.g., base station, data service provider, voice service server, etc.) to which mobile device 110 is connected.

In accordance with one embodiment, the presence status for mobile device 110 is determined based on mobile device 110's configuration or communication status (S220). Mobile device 110's presence status may be determined based on either a change in a particular device configuration or a change in communication status. For example, as noted earlier, a change in configuration may be detected as a result of turning mobile device 110 on or off, closing mobile device 110 or switching it to standby or other particular mode. Further, a change in mobile device 110's communication status may be detected due to mobile 110 establishing a voice session over the communications network with mobile device 120, for example.

In one embodiment, when a mobile device 110 receives a voice call, mobile device 110's presence status changes from available to unavailable, for example. When a change in presence status is detected (S230), then this change in status is communicated to communications server 100 (S240). The change in status, in one embodiment, is communicated to communications server 100 directly by mobile device 110, by sending a change of status notification. In other embodiments, change in presence status is indirectly communicated by way of an intermediary system (e.g., base station 150, data service provider, voice service server, telephony system switching center, etc.). The intermediary system detects this change in status, and in turn notifies communications server 100.

When communications server 100 is notified of a change in presence status, then communications server 100 generates an alert to other systems communicating with mobile device 110, indicating the new status. This alert notification can be in form of a broadcast to all devices communicating with mobile device 110 at the time, or in form of an automatic response to a particular system sending a message addressed to mobile device 110. For example, if mobile device 120 is engaged in a data session for communicating instant messages with mobile device 110, then an alert message will be transmitted to mobile device 120 when a voice session is established between mobile device 110 and a third device, if the voice session preempts the data session.

It is noteworthy that while the present invention is provided as applicable to a system in which a voice session preempts a data session, this application is by way of example. As such, the teachings of the invention may be applied in other contexts to broaden the scope of the invention to all communication sessions and systems where an alert message is needed to indicate one type of communication has preempted another type of communication.

The alert message can be in form of, for example, an audio signal or a visual display that would indicate mobile 110 is not available for data communications at that time. In some embodiments, messages forwarded to mobile device 110 are buffered, even if mobile device 110 is not present for real-time data communications. Buffered messages are later delivered to mobile device 110 when it becomes available. In other embodiments, any messages forwarded to mobile device 110 when it is not present are rejected, for example.

As such, various procedures may be implemented, in accordance to one or more embodiments, to notify or update a third party of the presence status of mobile device 110. For example, in one embodiment, the update procedure takes place immediately after mobile device 110's presence status changes. In other embodiments, the updated presence status is transmitted after a predetermined time period has lapsed. This lapse in time prevents multiple update procedures and reduces processing time, in case mobile device's status is changed temporarily for a short time, due to system or user error, for example.

In one embodiment, application software 1122 is implemented to also remind the user of mobile device 110 of the presence status. For example, a visual indicator may be displayed on mobile device 110 to signify the change in status. In such scenario, the subscribe may chose to restore the system settings to the appropriate status or level. For example, in certain embodiments, the user may be able to set a level of availability, request certain data messages to be blocked, or alternatively request for certain messages to be received, when a voice session is established.

In embodiments of the system, mobile devices, service provider servers, and communications servers comprise a controlled computing system environment that can be presented largely in terms of hardware components and software code executed to perform processes that achieve the results contemplated by the system of the present invention. A more detailed description of such system environment is provided below with reference to FIGS. 3A and 3B.

As shown, a computing system environment is composed of two environments, a hardware environment 1110 and a software environment 1120. The hardware environment 1110 comprises the machinery and equipment that provide an execution environment for the software. The software provides the execution instructions for the hardware. It should be noted that certain hardware and software components may be interchangeably implemented in either form, in accordance with different embodiments of the invention.

Software environment 1120 is divided into two major classes comprising system software 1121 and application software 1122. System software 1121 comprises control programs, such as the operating system (OS) and information management systems that instruct the hardware how to function and process information. Application software 1122 is a program that performs a specific task such as detecting changes in configuration data stored in mobile device 110 and reporting the updated data to the service provider.

Referring to FIG. 3A, an embodiment of the application software 1122 can be implemented as computer software in the form of computer readable code executed on a general purpose hardware environment 1110 that comprises a central processor unit (CPU) 1101, a main memory 1102, an input/output controller 1103, optional cache memory 1104, a user interface 1105 (e.g., keypad, pointing device, etc.), storage media 1106 (e.g., hard drive, memory, etc.), a display screen 1107, a communication interface 1108 (e.g., a network card, a blue tooth port, a modem, or an integrated services digital network (ISDN) card, etc.), and a system synchronizer (e.g., a clock, not shown in FIG. 3A).

Cache memory 1104 is utilized for storing frequently accessed information. A communication mechanism, such as a bi-directional data bus 1100, can be utilized to provide for means of communication between system components. Hardware Environment 1110 is capable of communicating with local or remotes systems connected to a communications network (e.g., a PAN or a WAN) through communication interface 1108.

In one or more embodiments, hardware environment 1110 may not include all the above components, or may include additional components for additional functionality or utility. For example, hardware environment 1110 can be a laptop computer or other portable computing device that can send messages and receive data through communication interface 1108. Hardware environment 1110 may also be embodied in an embedded system such as a set-top box, a personal data assistant (PDA), a wireless mobile device (e.g., cellular phone), or other similar hardware platforms that have information processing and/or data storage and communication capabilities. For example, in one or more embodiments of the system, hardware environment 1110 may comprise a PMG unit or an equivalent thereof.

In embodiments of the system, communication interface 1108 can send and receive electrical, electromagnetic, or optical signals that carry digital data streams representing various types of information including program code. If communication is established via a communications network, hardware environment 1110 may transmit program code through the network connection. The program code can be executed by central processor unit 1101 or stored in storage media 1106 or other non-volatile storage for later execution.

Program code may be transmitted via a carrier wave or may be embodied in any other form of computer program product. A computer program product comprises a medium configured to store or transport computer readable code or a medium in which computer readable code may be embedded. Some examples of computer program products are memory cards, CD-ROM disks, ROM cards, floppy disks, magnetic tapes, computer hard drives, and network server systems.

In one or more embodiments of the invention, processor 1101 is a microprocessor manufactured by Motorola, Intel, or Sun Microsystems Corporations, for example. The named processors are for the purpose of example only. Any other suitable microprocessor, microcontroller, or microcomputer may be utilized.

Referring to FIG. 3B, software environment 1120 is stored in storage media 1106 and is loaded into memory 1102 prior to execution. Software environment 1120 comprises system software 1121 and application software 1122. Depending on system implementation, certain aspects of software environment 1120 can be loaded on one or more hardware environments 1110.

System software 1121 comprises control software, such as an operating system that controls the low-level operations of hardware environment 1110. Low-level operations comprise the management of the system resources such as memory allocation, file swapping, and other core computing tasks. In one or more embodiments of the invention, the operating system can be Nucleus, Microsoft Windows CE, Microsoft Windows NT, Macintosh OS, or IBM OS/2. However, any other suitable operating system may be utilized.

Application software 1122 can comprise one or more computer programs that are executed on top of system software 1121 after being loaded from storage media 1106 into memory 1102. In client-server architecture, application software 1122 may comprise client software and server software. Referring to FIG. 1 for example, in one embodiment of the invention, client software is executed on mobile unit 110 and server software is executed on the service provider system (not shown) or communications server 100.

Software environment 1120 may also comprise web browser software 1126 for accessing content on a remote server. Further, software environment 1120 may comprise user interface software 1124 (e.g., a Graphical User Interface (GUI)) for receiving user commands and data. The received commands and data are processed by the software applications that run on the hardware environment 1110. The hardware and software architectures and environments described above are for purposes of example only. Embodiments of the invention may be implemented in any type of system architecture or processing environment.

Embodiments of the invention are described by way of example as applicable to systems and corresponding methods that facilitate updating configuration data of a mobile device stored in a service provider's database. In this exemplary embodiment, logic code for performing these methods is implemented in the form of, for example, application software 1122. The logic code, in one embodiment, may be comprised of one or more modules that execute on one or more processors in a distributed or non-distributed communication model.

It should also be understood that the programs, modules, processes, methods, and the like, described herein are but exemplary implementations and are not related, or limited, to any particular computer, apparatus, or computer programming language. Rather, various types of general-purpose computing machines or customized devices may be used with logic code implemented in accordance with the teachings provided, herein. Further, the order in which the methods of the present invention are performed is purely illustrative in nature. These methods can be performed in any order or in parallel, unless indicated otherwise in the present disclosure.

The methods of the present invention may be performed in either hardware, software, or any combination thereof. In particular, some methods may be carried out by software, firmware, or macrocode operating on a computer or computers of any type. Furthermore, such software may be transmitted in the form of a computer signal embodied in a carrier wave, and through communication networks by way of Internet portals or websites, for example. Accordingly, the present invention is not limited to any particular platform, unless specifically stated otherwise in the present disclosure.

The present invention has been described above with reference to preferred embodiments. However, those skilled in the art will recognize that changes and modifications may be made in these preferred embodiments without departing from the scope of the present invention. Other system architectures, platforms, and implementations that can support various aspects of the invention may be utilized without departing from the essential characteristics as described herein. These and various other adaptations and combinations of features of the embodiments disclosed are within the scope of the invention. The invention is defined by the claims and their full scope of equivalents.

1. In a mobile communications system, a method of updating presence status of a mobile device, the method comprising:
monitoring changes in the presence status of the mobile device; and
transmitting presence status data to a server system, in response to detecting a change in the presence status of the mobile device,
wherein the presence status indicates whether the mobile device can engage in a data communication session.

2. The method of claim 1, further comprising:
transmitting the presence status data to the server system in real time, wherein the server system is configured to notify a third party of the presence status of the mobile device.

3. The method of claim 1, wherein a voice telephony system determines the presence status of the mobile device based on voice session information associated with the mobile device.

4. The method of claim 1, wherein:
a third party is notified of the presence status, in response to transmitting a message addressed to the mobile device.

5. The method of claim 1, further comprising:
automatically changing the presence status of the mobile device, based on whether the mobile device is in use for voice communication.

6. The method of claim 1, further comprising:
automatically changing the presence status of the mobile device, based on whether the mobile device is in an open position.

7. The method of claim 1, further comprising:
automatically changing the presence status of the mobile device, based on whether the mobile device is on.

8. The method of claim 1, further comprising:
automatically changing the presence status of the mobile device, based on a first mode set for the mobile device.

9. The method of claim 8, wherein:
the first mode is set, when a user is in a meeting.

10. The method of claim 8, wherein:
the first mode is set, when the mobile device is in a vibration mode.

11. In a mobile communications server, a method of updating presence status of a mobile device, the method comprising:
automatically monitoring changes in the presence status of the mobile device; and
detecting a change in the presence status of the mobile device, in real time;
wherein the presence status indicates whether the mobile device can engage in a data communication session.

12. The method of claim 11, further comprising:
receiving the presence status data from the mobile device; and
generating an alert to communicate the presence status of the mobile device to another mobile device.

13. The method of claim 11, further comprising:
receiving the presence status data from the mobile device, within a predetermined time period; and
generating an alert to communicate the presence status of the mobile device.

14. The method of claim 13, wherein:
the alert is generated in response to receiving a message addressed for communication to the mobile device.

15. The method of claim 11, further comprising:
detecting a change in the presence status of the mobile device, based on whether the mobile device is in use for voice communication.

16. The method of claim 11, further comprising:
detecting a change in the presence status of the mobile device, based on whether the mobile device is in an open position.

17. The method of claim 1I, further comprising:
detecting a change in the presence status of the mobile device, based on whether the mobile device is on.

18. The method of claim 11, further comprising:
detecting a change the presence status of the mobile device, based on a first mode set for the device by a user.

19. A system for providing presence status of a first mobile device, the system comprising:
a monitoring unit for monitoring changes in the presence status of the first mobile device; and
a transmitter for transmitting presence status data to a server system, in response to detecting a change in the presence status of the first mobile device,
wherein the presence status indicates whether the first mobile device can engage in a data communication session, and
wherein the server system notifies a second mobile device of the presence status of the mobile device, in real time.

20. The system of claim 19, wherein:
the second mobile device is notified of the presence status of the first mobile device, in response to the second mobile device communicating at least one data message addressed to the first mobile device, when the presence status indicates that the first mobile device is in use for voice communications.
